(19) United States
(12) Patent Application Publication
(10) Pub. No.: US 2014/0297048 A1
(43) Pub. Date: Oct. 2, 2014

(54) ENABLING INTELLIGENT HOT WATER DISTRIBUTION WITHIN A PLUMBING SYSTEM

(71) Applicants: BRIAN K. BUCHHEIT, DAVIE, FL (US); CASSANDRA J. OLIVER, WESTON, FL (US)

(72) Inventors: BRIAN K. BUCHHEIT, DAVIE, FL (US); CASSANDRA J. OLIVER, WESTON, FL (US)

(21) Appl. No.: 14/228,609

(22) Filed: Mar. 28, 2014

Related U.S. Application Data
(60) Provisional application No. 61/806,026, filed on Mar. 28, 2013.

(51) Int. Cl. G05D 7/06; H04L 12/28

(52) U.S. Cl. CPC G05D 7/0617; H04L 12/2803
USPC 700/283; 700/282

(57) ABSTRACT

A hot water heater sensor can be configured to determine a level of hot water available for resident use. A set of facets can control a distribution of hot water within a residence. Communication transceivers can be communicatively linked to the hot water heater and the facets to exchange digital information regarding hot water availability and consumption to a home-automation communication hub. A user device with a graphical user interface can present information derived from the hot water heater sensor and the facets to control, monitor, regulate, or change hot water availability to resident members via the graphical user interface.

### CROSS-REFERENCE TO RELATED APPLICATIONS

This Utility application converts and claims the benefit of U.S. Provisional Patent Application No. 61/806,026, filed 28 Mar. 2013 filed with docket number POND130012P. The entire contents of U.S. Application No. 61/806,026 are incorporated by reference herein.

### BACKGROUND

The present invention relates to the field of home automation and, more particularly, to enabling intelligent hot water distribution within a plumbing system.

Hot water heaters are a common household appliance which can provide hot water throughout a household. Since many households include multiple persons, each person can utilize a portion of the available hot water within the hot water heater. Sometimes, one person can inadvertently dominate the hot water usage resulting in little hot water for other persons within the household. For example, when a family member takes a long shower, the available hot water can be exhausted, resulting in subsequent showers to receive little or no hot water. This problem has been traditionally solved by oral agreements to limit shower times and hot water usage. However, these agreements can be easily breached and forgotten which can result in constant conflict between household members.

### BRIEF SUMMARY

One aspect of the present invention can include a system, a computer program product, a method, and an apparatus for enabling intelligent hot water distribution within a plumbing system. A hot water heater sensor can be configured to determine a level of hot water available for resident use. A set of facets can control a distribution of hot water within a residence. Communication transceivers can be communicatively linked to the hot water heater and the facets to exchange digital information regarding hot water availability and consumption to a home-automation communication hub. A user device with a graphical user interface can present information derived from the hot water heater sensor and the facets to control, monitor, regulate, or change hot water availability to resident members via the graphical user interface.

Another aspect of the present invention can include a method, an apparatus, a system, and a computer program product, for enabling intelligent hot water distribution within a plumbing system. An application for a computing device can control hot water delivered to residences through an in-home hot water system. The application can permit thresholds to be established for the in-home hot water system per person to ensure no single person is able to consume hot water for the entire household thereby ensuring each person in the home is permitted some time divisible time period of hot water usage. The period can be established through the graphical user interface.

Yet another aspect of the present invention can include a method, a system, a computer program product, and an apparatus for enabling intelligent hot water distribution within a plumbing system. The apparatus can include a data transceiver and a flow rate control actuated by data received by the data transceiver. The availability of hot water dispensed via the faucet can be externally restricted via an water system automation application linked to a dynamic reading of available hot water acquired from a hot water level sensor integrated into a hot water tank or system. The shared hot water can be able to be restricted per person to ensure availability of hot water to all residences, in accordance with settings established via the water system automation application.

### BRIEF DESCRIPTION OF THE SEVERAL VIEWS OF THE DRAWINGS

FIG. 1 is a schematic diagram illustrating a scenario and a flow for enabling intelligent hot water distribution within a plumbing system in accordance with an embodiment of the inventive arrangements disclosed herein.

FIG. 2 is a schematic diagram illustrating a scenario for enabling intelligent hot water distribution within a plumbing system in accordance with an embodiment of the inventive arrangements disclosed herein.

FIG. 3 is a schematic diagram illustrating a set of interfaces for enabling intelligent hot water distribution within a plumbing system in accordance with an embodiment of the inventive arrangements disclosed herein.

FIG. 4 is a schematic diagram illustrating a set of interfaces for enabling intelligent hot water distribution within a plumbing system in accordance with an embodiment of the inventive arrangements disclosed herein.

FIG. 5 is a schematic diagram illustrating an embodiment for enabling intelligent hot water distribution within a plumbing system in accordance with an embodiment of the inventive arrangements disclosed herein.

FIG. 6 is a schematic diagram illustrating a method for enabling intelligent hot water distribution within a plumbing system in accordance with an embodiment of the inventive arrangements disclosed herein.

### DETAILED DESCRIPTION

The present disclosure is a solution for enabling intelligent hot water distribution within a plumbing system. In the solution, a hot water sensor within a hot water heater can be utilized to aid in hot water distribution for a plumbing system. For example, the hot water sensor can determine the amount of hot water available which can be utilized to even distribute hot water throughout a home. In one instance, each faucet connected to the plumbing system can include a flow sensor which can determine usage metrics. In the instance, usage metrics can be employed to control usage based on the amount of hot water available in the hot water heater. For example, the disclosure can permit a family to limit hot water usage in a shower to four gallons per person enabling equal access to hot water for each family member. It should be appreciated that the disclosure can perform granular water distribution, water temperature, flow rate, and the like.

As used in embodiments herein, level is a measurement of hot water in a system. Often the actual level of water in a hot water tank is relatively constant but a degree that this constant level is heated is variable. People commonly refer to this a “running out of” hot water, when from a physical perspective, the heated water is of a lesser temperature than desirable—but it hasn't run out. Hence, references to “level” of hot water may refer to an effective amount of heated water before the water feels cool or overly cool for its intended purposes. Other systems exist that actually have a level of water that is heated, which also apply, but a majority of conventional hot water heaters maintain a relatively constant level. A major difference is between hot water systems relying on a hot-water tank, and tankless hot water heaters.

One of ordinary skill understands in context, “level” of hot water refers to a quantity of available water at a desired temperature for use as ‘hot’ water. This availability often must consider flow rate. Typical flow for bathtubs is 4 gallons per minute (GPM), for a washing machine 3 GPM, for a dishwasher 3 GPM, for a shower head 2.5 GPM, for a kitchen faucet 2.2 GPM, and for a bathroom faucet 1.5 GPM. A “house usage profile” can be developed and maintained that determines an amount of necessary “reserve” hot water needed to be maintained for typical household use. The “excess” may be considered a level of available hot water for targeted purposes (such as taking a shower without “using” all the hot water. Time of day and per-person profiles on household use are a consideration. Systems are contemplated herein, where additional “available” or excess hot water can be provided by atomically timing routine household operations that consume water (that are able to be delayed at times of high usage) to increase an effective amount of hot water available. For example, a washing machine or dish washer may each consume considerable amounts of hot water, but can be delayed during times of high hot-water use (by an automated system in some embodiments to minimize user-experienced hassle) in some contemplated embodiments.

For example, recommended temperature settings (from the Department of Energy) for tank-based hot water heaters is 120 degrees to 140 degrees (which is the default setting of most manufactories). This setting can be adjusted. An amount of hot water available (GPM at a desired temperature) can be dependent on this temperature, as well as other factors. A desired temperature may vary by person and use, which is also considered within this disclosure. For example, for some people a temperature of 105 degrees may be a desired temperature for a “hot shower.” Other household members may desire a temperature of 110 or 115 degrees. The actual usages and special conditions can be calculable factors used by the system detailed herein. Another factor may be the temperature of “cold water” for the household. Cold water entering the house may be 40 degrees Fahrenheit on average, but people living in cold/warm environments may have a different default temperature. Water provided to the house is a blend of the “cold” weather and the “hot” water coming from a hot water tank (or other hot water heater, like a tankless system). The hot and cold water can be blended in different ratios to achieve any temperature between the two extremes of the cold and the hot thresholds.
Although not intended to be comprehensive, the following are illustrative of available knowledge relating to hot water systems, which one of ordinary skill is able to utilize for the disclosure: Aguilar et al.; CBEEDAC; Domestic Water Heating and Water Heater Energy Consumption in Canada; Canadian Building Energy End-Use Data and Analysis centre; April 2005; pages 1-82; Defra; Measurement of Domestic Hot Water Consumption in Dwellings; energy saving trust; 2008; pages 1-62; Dr. Benjamin P. L. Ho; Department of Mechanical Engineering; The University of Hong Kong; Session 2: Hot Water Supply; MEBS6000 Utility Services; pages 1-71; CEN/TC 228 WI 032; Heating systems in buildings—Method for calculation of system energy requirements and system efficiencies—Part 3-1 Domestic hot water systems, characterization of needs (tapping requirements); pages 1-20; A O Smith—Hot water requirements apartments; March 2010; pages 1-2; Otto Paulsen—Model for calculation of energy consumption and efficiency for hot tap water preparation; version 3; May 1999; pages 1-16; PG&E—Codes and standards enhancement initiative; Hourly Water Heating calculation; Draft May 15, 2002; pages 1-18; EPA WaterSense—Guide for Efficient Hot Water Delivery Systems; Version 1.1; pages 1-28; Werner Weiss—AEE INTEC; Design of solar thermal systems—calculation methods; Institute for sustainable technologies, Austria; pages 1-21; Danfoss—Domestic hot water circulation system—Background information; pages 1-12; The Engineering ToolBox; Domestic Hot Water System—Design procedure; pages 1-5; Bhatia A.—Hot Water Plumbing Systems; PDHonline Course M151 (3 PDH); pages 1-64; Each of these documents is to be considered incorporated by reference herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

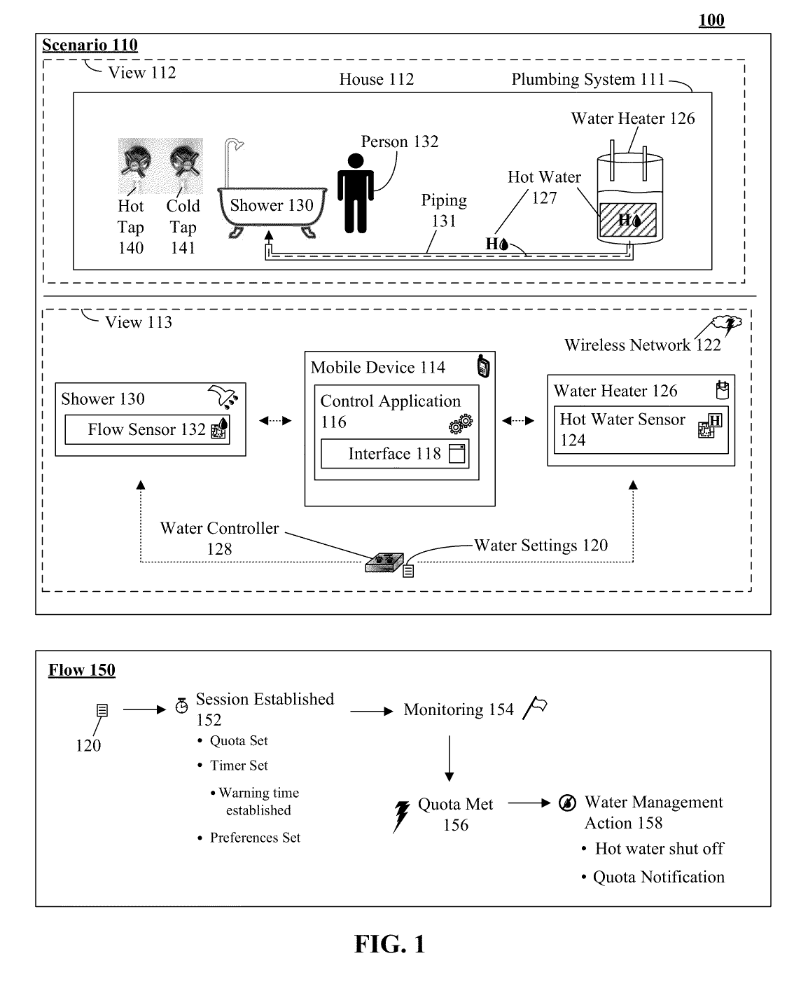

FIG. 1 is a schematic diagram illustrating a scenario 110 and a flow 150 for enabling intelligent hot water distribution within a plumbing system in accordance with an embodiment of the inventive arrangements disclosed herein. Scenario 110 and/or flow 150 can be performed in the context of scenario 210, interfaces 310, 350, 410, 450, embodiment 500 and/or method 600. Scenario 110 can include a plumbing system 111 view 112 and a electronic component view 113. Flow 150 can correspond to events occurring within scenario 110.

As used herein, a plumbing system 111 can be a system of pipes, drains fittings, valves, valve assemblies, and/or devices installed in a building for the distribution of water for drinking, heating, washing, and/or the removal of waterborne wastes. It should be appreciated that plumbing is usually distinguished from water supply and sewage systems, in that a plumbing system serves one building, while water and sewage systems serve a group of buildings. System 111 can include, but is not limited to, shower 130, piping 131, water heater 126, tap 140, 141, and the like.

Plumbing fixtures can be an exchangeable device which can be connected to an existing plumbing system to deliver and drain away water but which can also configured to enable a particular use. Fixtures can include, but is not limited to, bathtubs, showers, faucets, kitchen sinks, utility sinks, and the like. Plumbing fixtures can include one or more water outlets and a drain. It should be appreciated that fixtures can include one or more taps, which can be a valve controlling release of hot and/or cold water (e.g., hot tap 140, cold tap 141). That is, shower 130 can include a mixer tap which can allow water to emerge at any temperature between that of the hot and cold water supplies.

Water heater 126 can be a domestic water heating appliance which can uses a hot water storage tank to maximize heating capacity and provide instantaneous delivery of hot water 127. Heater 126 can include a hot water sensor 124 which can determine the quantity of hot water 127 within heater 127. Sensor 124 functionality can include, but is not limited to, water 127 temperature, water 127 flow rate, water 127 pressure, and the like. In one instance, controller 128 can be a component of sensor 124 and/or heater 126. Water heater 126 can be connected to shower 130 via one or more piping 131. Piping 131 can include, but is not limited to tubing, valves, elbows, tees, unions, and the like. In one instance, piping 131 can include a hot water piping and a cold water piping.

In scenario 110, a house (not shown) can include the plumbing system 111 which can include piping 131, shower 130, and water heater 126 which can be used by person 132. System 111 can function to provide hot and/or cold water throughout one or more portions of the house (e.g., bathroom, kitchen). For example, when person 132 utilizes shower (e.g., via hot tap 140, cold tap 141), the appropriate temperature water can be distributed to the shower 130. In one instance, the disclosure can utilize flow sensor 132, hot water sensor 124, and/or water controller 120 to dynamically manage the hot water 127 allocation and/or distribution to person 132. In the instance, water controller 128 can utilize water settings 120 to distribute a specified amount and temperature of hot water 127 to person 132 in shower 130.

In one embodiment, person 132 identity can be determined via one or more traditional and/or proprietary mechanisms. In the embodiment, person 132 can login to a control application 116 to access a quantity of hot water 127. For example, when a person enters a bathroom, device 114 can identify the person 132 via a voice recognition mechanism. It should be appreciated that person 132 identity can be determined based on biometrics, including, but not limited to, fingerprint, facial features, and the like. In one instance, person 132 identification can trigger the selection of an appropriate water settings 120 for the person. In the instance, previously determined water settings 120 can be communicated to water heater 126 to enable heater 126 to provide a quantity of hot water 127 to shower 130. That is, when a person 132 wants to take a shower, the person 132 can interact with an login interface (e.g., 118) to setup shower 130 for personalized access. In one instance, user identification and water setting selection can be a portion of a session initiation. In the instance, a session can be utilized to track hot water usage, user preferences, behavioral biometrics, and the like. It should be appreciated that default water settings 120 can be established if settings 120 are not associated with a person 132.

In one embodiment, one or more fixtures (e.g., shower, faucet) can be statically assigned to a user. In the embodiment, static assignment an relieve the requirement for user identification/authentication. For example, when a family member only uses a particular shower, the member can be assigned to the shower, permitting the member to use the shower without requiring the user to perform any additional actions. That is, the disclosure can function transparently to the person.

Shower 130, mobile device 114, water controller 128, and heater 126 can be communicatively linked via a wireless network 122. Network 122 can permit real-time or near real-time communication between the components. In one instance, mobile device 114 can execute a control application 116 which can manage hot water 127 access within the house via settings 120. Application 116 can include a control interface 118 which can permit configuration, monitoring, and control of hot water 127 to shower 130 through usage of settings 120.

Flow sensor 132 can communicate with device 114 which can provide real-time or near real-time usage metrics (e.g., total time, quantity of hot water used). In one instance, settings 120 can include a quota setting for person 132. In the instance, quota can be a quantity of hot water, a duration of hot water usage, and the like. That is, settings 120 can be utilized to regulate the distribution of hot water 127 to one or more persons.

Flow 150 can model a use case of the disclosure which can permit water allocation based on one or more water settings 120. Water settings 120 can be processed at the beginning of a session during session establishment (e.g., session established 152). When session established 152 can be performed, a quota of hot water, a timer (e.g., time quota), and one or more preferences for water distribution can be set. During the session, monitoring 154 can be performed. Monitoring 154 can be performed by flow sensor 132, controller 128, and/or hot water sensor 124. Monitoring 154 can include, but is not limited to, usage assessment, metric collection, and the like. During monitoring, quota settings can be continually evaluated to determine quota satisfaction. When quota met 156 is reached, a water management action 158 can be performed. Water management action 158 can include, but is not limited to, hot water shut off, quota notification presentation, and the like. For example, when person 132 has utilized their allocated hot water supply, a quota limit notification can be presented within an interface 118 of mobile device 114 and the hot water 127 can be suppressed to shower 130. That is, hot water 127 can cease to be supplied to shower 130 regardless of hot tap 140 manipulation (e.g., opening the tap).

Drawings presented herein are for illustrative purposes only and should not be construed to limit the invention in any regard. It should be appreciated that water heating can be a thermodynamic process which uses an energy source to heat water above its initial temperature. It should be appreciated that heater 126 can utilize one or more traditional and/or proprietary energy sources including, but not limited to, natural gas, propane, electricity, solar energy, and the like. It should be appreciated that controller 128 can be an optional component of the scenario 110. It should be understood that the disclosure is not limited to a household and can include any building with a plumbing system and/or water heater 126 distribution (e.g., apartment building). It should be appreciated that user identification/authentication can include traditional mechanisms including, but not limited to, username/password combination, PINs, and the like.

Network 122 can be an electrical and/or computer network connecting one or more components 132, 114, 124. Network 122 can include, but is not limited to, twisted pair cabling, optical fiber, coaxial cable, and the like. Network 122 can include any combination of wired and/or wireless components. Network 122 topologies can include, but is not limited to, bus, star, mesh, and the like. Network 122 types can include, but is not limited to, Local Area Network (LAN), Wide Area Network (WAN), Virtual Private Network (VPN) and the like. In one instance, network 122 can include a private WiFi network of a residential routing device. For example, network 122 can be a 802.11n network of a gateway DSL router.

It should be appreciate that interface 240, 310, 350, 410, 450 can be screens (e.g., interface 118) of a control application (e.g., application 116) associated with a computing device (e.g., mobile device 114). The control application can include multiple users, an administrative user, and the like. For example, the application can permit an administrative user to configure hot water distribution and allow users to only view usage reports. It should be appreciated that control application can include an arbitrary quantity of screens and is not limited to the interfaces presented herein.

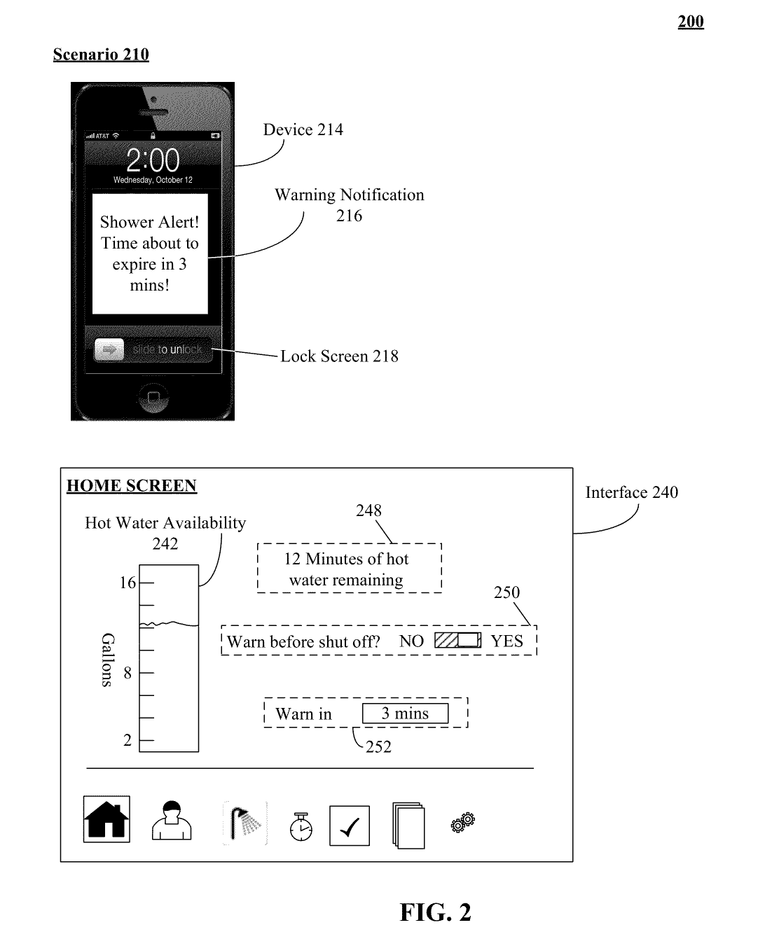

FIG. 2 is a schematic diagram illustrating a scenario 210 for enabling intelligent hot water distribution within a plumbing system in accordance with an embodiment of the inventive arrangements disclosed herein. Scenario 210 can be present in the context of scenario 110, flow 150, interfaces 310, 350, 410, 450, embodiment 500, and/or method 600. Scenario 210 can include a device 214 presenting a lock screen and an interface 240 (e.g., upon device unlock).

In scenario 210, a warning notification 216 can be presented within a lock screen 218 of a device 214. Notification 216 can be presented in the context of flow 150 (e.g., prior quota met 156). For example, notification 216 be a warning alert which can indicate a duration of hot water usage is about to end which can help a user manage water consumption for the duration of allowed usage. In one instance, notification 216 can include a visual and/or aural alert. For example, a visual alert can include a blinking LED on device 214.

In interface 240, a home screen of an application (e.g., control application 116) can present a hot water availability 242. Hot water availability 242 can be a graphical illustration and/or a numerical quantity of the available hot water within water heater (e.g., heater 126). For example, availability can include a graphic which represents the tank of a hot water heater (e.g., 126) with an appropriate fill line to indicate the amount of water in the tank. It should be appreciated that availability 242 can be a static and/or dynamic display. In one instance, availability 242 can change in real-time or near real-time based on hot water consumption.

In one embodiment, interface 240 can include, but is not limited to estimation 248, warning setting 250, warning timer 252, and the like. Estimation 248 can be a calculation of the amount of hot water available at a current flow rate (e.g., when no faucets are running or when one or more faucets are running). For example, when the flow rate of a shower is 2.2 gallons per minute, a calculation can be performed to determine the quantity of time before hot water within the heater can be exhausted. In one instance, estimation can be performed based on a per user basis. For example, when the flow rate of a shower is 2.2 gallons per minute, a calculation can be performed based on a setting associated with a person (e.g., quota) to determine the time left before the quota is met.

Warning settings 250 can permit the customization of a warning option to alert a person of an impending hot water usage time and/or amount. For example, warning setting 250 can permit a warning to be presented before hot water shut off is performed. In warning timer 252, a value can be set to trigger the warning prior to a water management action being performed. For example, timer 252 can allow a three minute warning notification (e.g., notification 216) to be presented within device 214 before hot water distribution is throttled.

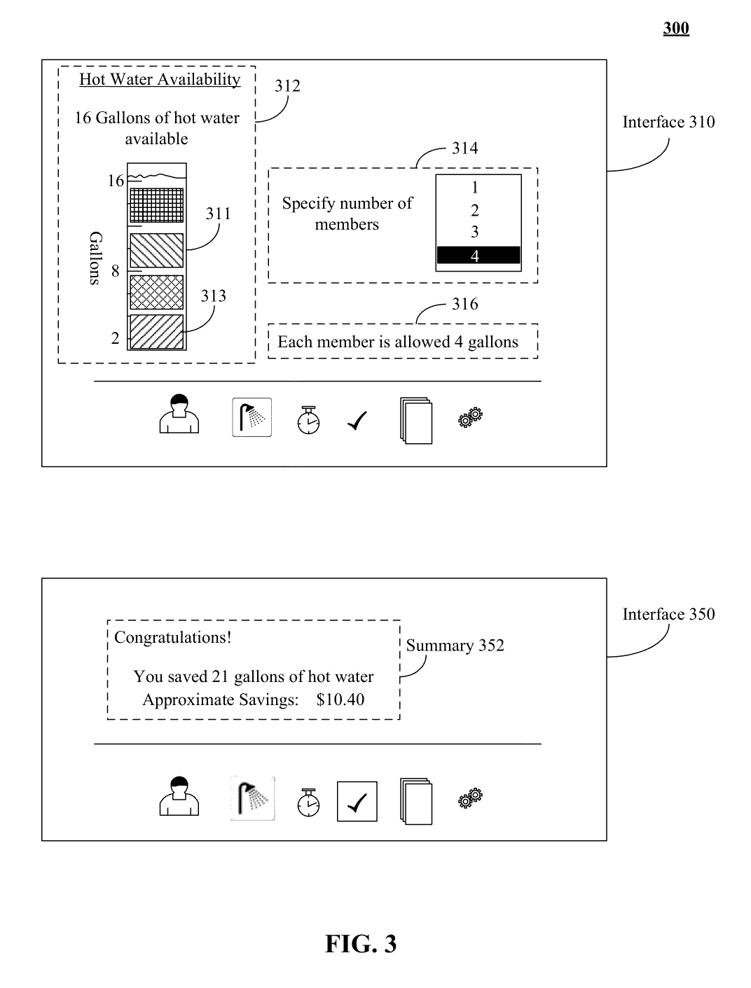

FIG. 3 is a schematic diagram illustrating a set of interfaces 310, 350 for enabling intelligent hot water distribution within a plumbing system in accordance with an embodiment of the inventive arrangements disclosed herein. Interfaces 310, 350 can be present in the context of scenario 110, flow 150, scenario 210, interfaces 410, 450, embodiment 500, and/or method 600.

In interface 310, a hot water availability information 312, member specification 314, and/or calculation 316 can be presented to enable hot water allocation within a residence. In one instance, specification 314 can permit an equal distribution of a quantity of hot water based on the number of members in a residence. Calculation 316 can present a recommended value for each member to allow fair distribution of hot water. For example, a family of four can be each allocated four gallons of hot water from a water heater with a sixteen gallon availability. It should be appreciated that calculation 316 can be tailored to allow a reserve amount of hot water to be kept. For example, each member is allowed three gallons of the sixteen gallons, permitting an excess of four gallons to remain after allocated use. In one embodiment, a graphic 311 can reflect allocation settings within specification 314. In the embodiment, graphic 311 can present an appropriate quantity of visual placeholders 313 which can visually indicate a quantity of hot water within a hot water heater tank for each member.

In interface 350, a summary 352 can be presented based on usage metrics for a duration of time. Summary 352 can include, but is not limited to, quantity of water saved, approximate savings, and the like. For example, a weekly summary can be presented within an interface of a device to indicate that the household saved ten dollars and forty cents from water allocation. Summary 352 can be manually and/or automatically presented. In one instance, summary 352 can be presented when a target threshold is met. In the instance, a target threshold can be established manually and/or automatically to enable goal oriented planning for reducing hot water consumption. For example, summary 352 can be utilized to indicate progress (e.g., 5 gallons to go) towards a hot water conservation target (e.g., 25 gallons per week).

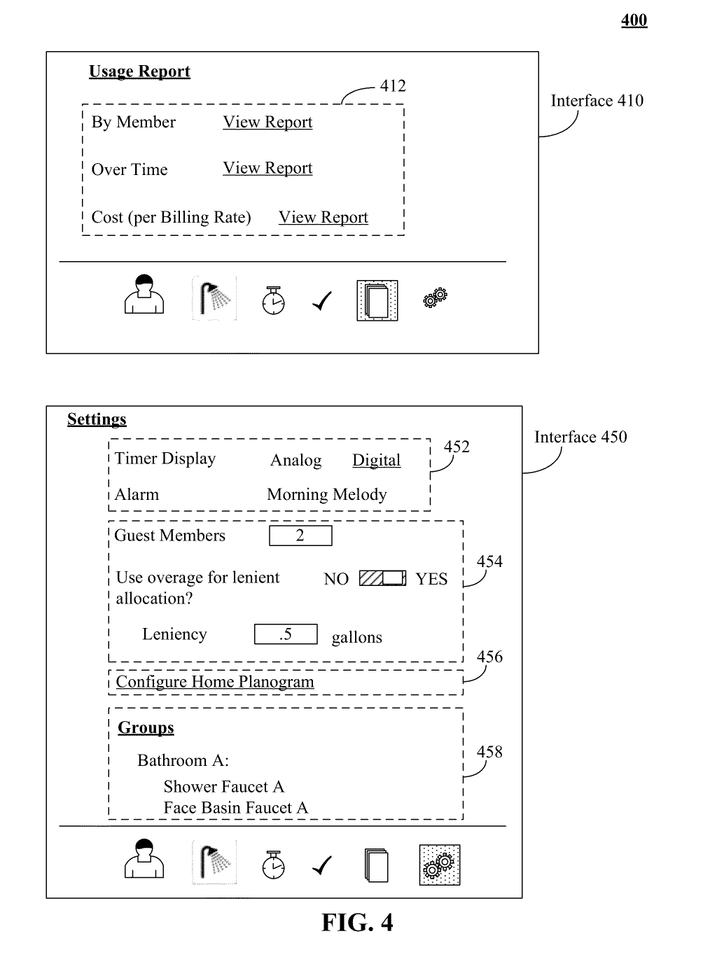

FIG. 4 is a schematic diagram illustrating a set of interfaces 410, 450 for enabling intelligent hot water distribution within a plumbing system in accordance with an embodiment of the inventive arrangements disclosed herein. Interfaces 410, 450 can be present in the context of scenario 110, flow 150, scenario 210, interfaces 310, 350, embodiment 500, and/or method 600.

In interface 410, a usage report 412 can be generated within an interface of an application (e.g., control application 116). Usage report 412 can present one or more usage metrics, metric analysis, and the like. For example, report 412 can present a report by member, a report over an user specified period of time, a cost analysis, and the like. It should be appreciated that report 412 can include graphs, visualizations, and the like. In one instance, report 412 can be exported to one or more traditional and/or proprietary formats (e.g., MICROSOFT EXCEL, ADOBE PORTABLE DOCUMENT FORMAT).

In interface 450, one or more usage options 452-458 can be presented. In option 452, options associated with a timer and/or notification presentation can be configured. Option 452 can include, but is not limited to, visual customizations, aural customizations, and the like. For example, option 452 can permit a traditional digital clock display and a musical alarm tone to be played when a time quota is met.

Option 454 can include, but is not limited to, guest usage configuration, leniency settings, and the like. In option 454, a quantity of guest users can be configured to allow temporary adjustment to water distribution. Distribution can be configured to affect an individual quota, all quotas, and the like. For example, when an overnight guest is present within a household, quotas can be temporarily adjusted to permit the guest to use a quantity of hot water without dramatically affecting (e.g., reduce all quotas by a half gallon) established quotas of other household members. In one instance, leniency settings can be configured to allow or disallow overage of quota allocations. In the instance, settings can permit a quantity of hot water and/or a duration of hot water to be used over the established quota for a person. For example, each person can be allowed to use half a gallon over their allotted quota of water when necessary.

In one embodiment, option 456 can permit a planogram view of a residence, enabling a visualized configuration of the disclosure. In one embodiment, planogram view can show faucets (e.g., bathroom showers, face basin sinks), sensor status based on location, usage metrics, and the like. For example, planogram can present a high level view of major hot water usage and/or distribution (e.g., kitchen, powder room).

In option 458, one or more groupings of fixtures can be established to permit flexible water usage from multiple faucets by a single person. For example, option 458 can permit a shower faucet and a face basin faucet to be grouped into a “Bathroom A” group. That is, when a person is using a bathroom the person can utilize hot water from either faucet which can be properly tracked and deducted from the appropriate quota.

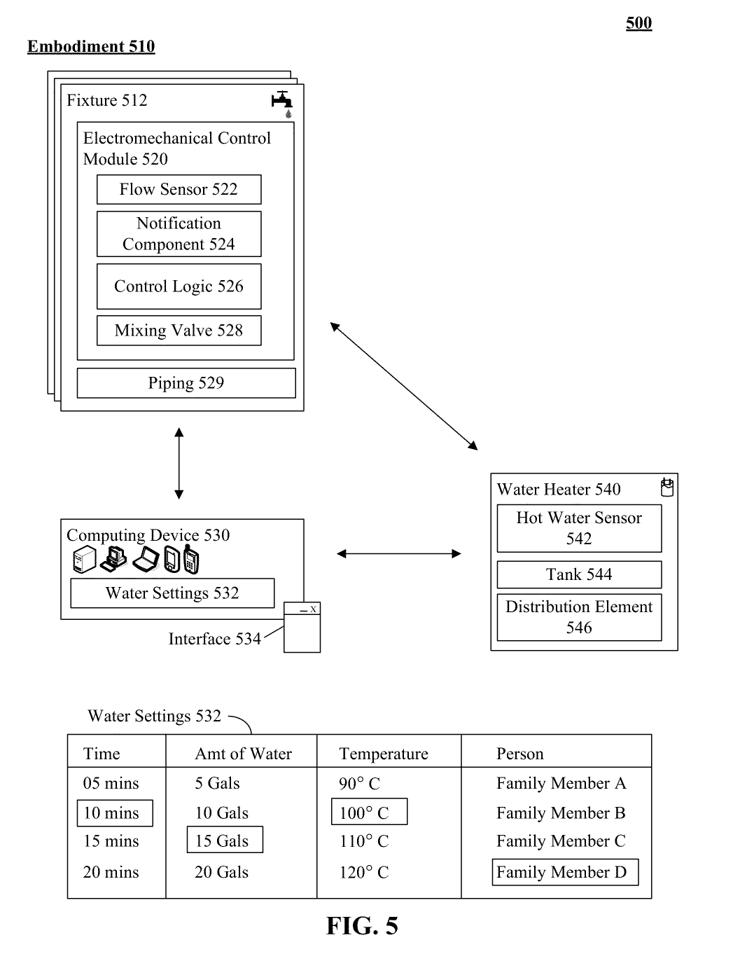

FIG. 5 is a schematic diagram illustrating an embodiment 500 for enabling intelligent hot water distribution within a plumbing system in accordance with an embodiment of the inventive arrangements disclosed herein. Embodiment 500 can be performed in the context of scenario 110, flow 150, scenario 210, interface 310, 350, 410, 450, and/or method 600.

In embodiment 510, a fixture 512, a computing device 530, and a water heater 540 can be communicatively linked. Fixture 512 can include, but is not limited to, an electromechanical control module 520, piping 529, and the like. Electromechanical control module 520 can include, but is not limited to, flow sensor 522, notification component 524, control logic 526, mixing valve 528, and the like. In one instance, module 520 can conform to traditional and/or proprietary electromechanical mixing modules.

Flow sensor 522 can include, but is not limited to, a moisture sensor, a pressure sensor, and the like. It should be appreciated that flow sensor can be arbitrarily complex. Notification component 524 can be a hardware/software component for receiving and/or transmitting notifications associated with device 530 and/or heater 540. In one instance, component 524 can include a transceiver, a logic circuit, and the like. In one embodiment, component 524 can be utilized to perform interprocess communication between device 530, 540. Control logic 526 can be a hardware/software element for controlling operation of fixture 512, fixture 512 components, device 530, and/or heater 540. Mixing valve 528 can be a hardware component for mixing a hot water supply and a cold water supply. Valve 528 can operate under control of logic 526 and/or settings 532.

Computing device 530 can include, but is not limited to water settings 532, interface 534, and the like. In one instance, settings 532 can be set via one or more tabular entry selection. In the instance, settings 532 can permit individualized selection of a time, an amount of hot water, a temperature setting for the hot water, and a person associated with the setting. For example, a family member D can be allowed 15 gallons of hot water at 100 degrees Celcius or 10 minutes of hot water, whichever quota is met first. It should be appreciated that the setting 532 can be arbitrarily complex.

Hot water heater 540 can include, but is not limited to, hot water sensor 524, tank 544, distribution element 546, and the like. Sensor 524 can include, but is not limited to, a moisture sensor, a flow rate sensor, a thermostat, and the like. Tank 544 can be a water tank able to heat water from an initial temperature. Distribution element 546 can include, but is not limited to, a piping, a control valve, and the like.

In one embodiment, the disclosure can be a portion of an Application Programming Interface (API), a hardware/software plug-in, and the like. For example, the disclosure can be a drop-in upgrade for an existing tank based water heater. It should be appreciated that the disclosure can operate in concert with traditional tank based water heaters, hybrid water heaters, tankless water heaters (e.g., on demand), and the like.

Drawings presented herein are for illustrative purposes only and should not be construed to limit the invention in any regard. It should be appreciated that module 520 can be an optional component of faucet 512. It should be appreciated that one or more components within embodiment 510 can be optional components permitting that the disclosure functionality be retained. It should be understood that module 520 components can be optional components providing that module 520 functionality is maintained. It should be appreciated that one or more components of module 520 can be combined and/or separated based on functionality, usage, and the like.

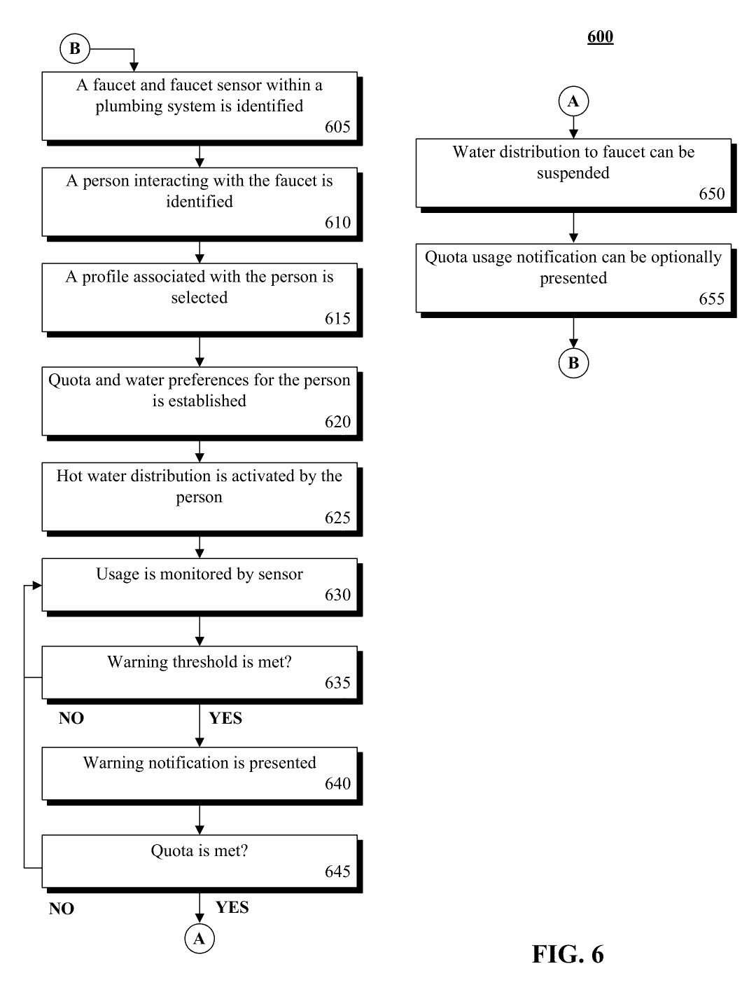

FIG. 6 is a schematic diagram illustrating a method 600 for enabling intelligent hot water distribution within a plumbing system in accordance with an embodiment of the inventive arrangements disclosed herein. Method 600 can be performed in the context of scenario 110, flow 150, scenario 210, interfaces 310, 350, 410, 450, and/or embodiment 500.

In step 605, a faucet and faucet sensor within a plumbing system can be identified. Identification can be performed responsive to detection of a faucet activation. For example, when a person opens a hot or cold water tap of a faucet, faucet and/or sensor can be identified. In step 610, a user interacting with the faucet can be identified. In one instance, identification can be performed based on fingerprint recognition from “smart faucets” with capacitive touch technology. For example, when a person grabs a capacitive touch handle, the handle can read the fingerprint of the person and identify an appropriate user account within the system associated with the person. In step 615, a profile associated with the person (e.g., user account) can be selected. In step 620, a quota and/or a water preference for the user can be established. In step 625, hot water distribution can be activated by the user. For example, when the person opens the hot water tap, an appropriate quantity of hot water can be distributed from a mixing valve associated with the tap. In step 630, water usage can be monitored by the sensor. In step 635, if a warning threshold is met, the method can continue to step 640, else return to step 630. In step 640, a warning notification can be presented. In step 645, if the quota is met, the method can continue to step 650, else return to step 630. In step 650, the water distribution can be suspended. In step 655, an quota usage notification can be presented. The method can return to step 605.

Drawings presented herein are for illustrative purposes only and should not be construed to limit the invention in any regard. It should be appreciated that method 600 can be performed in real-time or near real-time. Further, method 600 can be performed in serial and/or in parallel. Method 600 can be continuously repeated for the duration of water heater operation.

The flowchart and block diagrams in the FIGS. 1-6 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A system for hot water distribution comprising:
a hot water heater sensor configured to determine a level of hot water available for resident use;
a set of facets controlling a distribution of hot water within a residence;
communication transceivers communicatively linked to the hot water heater and the facets to exchange digital information regarding hot water availability and consumption to a home-automation communication hub; and
at least one user device comprising a graphical user interface presenting information derived from the hot water heater sensor and the facets to control, monitor, regulate, or change hot water availability to resident members via the graphical user interface.

2. The system of claim 1, further comprising:
the graphical user interface comprising of a graphic or value indicating a level of available hot water for use in a residence, wherein the value is dynamically determined using a hot water heater sensor in a hot water tank of the residence.

3. The system of claim 1, wherein the graphic or value dynamically and automatically changes as the hot water heater sensor indicates a quantity of hot water heater in the hot water tank changes.

4. The system of claim 1, further comprising:
the graphical user interface comprising of a listing of one or more faucet units in a residence able to be restricted from the graphical user interface for dissemination of hot water, based on at least one of a user feedback and a user input entered via the graphical user interface.

5. The system of claim 1, further comprising:
the graphical user interface permitting the grouping of a set of shower and faucet units within the residence such that the quantity of hot water available is approximately split between the shower and faucet units of the set.

6. A graphical user interface for hot water distribution comprising:
a graphical user interface comprising of a graphic or value indicating a level of available hot water for use in a residence, wherein the value is dynamically determined using a hot water heater sensor in a hot water tank of the residence.

7. The graphical user interface of claim 6, wherein the graphic or value dynamically and automatically changes as the hot water heater sensor indicates a quantity of hot water heater in the hot water tank changes.

8. The graphical user interface of claim 6, further comprising:
a listing of one or more shower units in a residence able to be restricted from the graphical user interface for dissemination of hot water, based on at least one of a user feedback and a user input entered via the graphical user interface.

9. The graphical user interface of claim 6, further comprising:
a listing of one or more faucet units in a residence able to be restricted from the graphical user interface for dissemination of hot water, based on at least one of a user feedback and a user input entered via the graphical user interface.

10. The graphical user interface of claim 6, further comprising:
permitting the grouping of a set of shower and faucet units in a residence, wherein the group is associated with a hot water quota, wherein the quota is approximately split between the shower and faucet units of the set.

11. The graphical user interface of claim 6, further comprising:
an application for a computing device for controlling hot water able to be delivered to residences through an in-home hot water system, wherein said application permits thresholds to be established for the in-home hot water system per person to ensure no single person is able to consume hot water for the entire household, thereby ensuring each person in the home is permitted some time divisible time period of hot water usage, wherein the period is established through the graphical user interface.

12. The application of claim 11, wherein the application is directly linked to in-home devices for providing hot water to the home, wherein settings of the application inhibit or contain delivery of hot water in accordance with application settings via a plumbing system of the home.

13. The application of claim 11, configured to automatically prompt a user of the device when availability of hot water in a household is scarce, wherein the user is able to prevent the hot water exhaustion before the user is able to utilize the hot water, having hot water dependent on a shared hot water tank.

14. A faucet in a residence/commercial establishment comprising:
a data transceiver;
a flow rate control actuated by data received by the data transceiver, wherein availability of hot water dispensed via the faucet is externally restricted via an water system automation application linked to a dynamic reading of available hot water acquired from a hot water level sensor integrated into a hot water tank or system, whereby shared hot water is able to be restricted per person to ensure availability of hot water to all residences, in accordance with settings established via the water system automation application.

15. The faucet of claim 14, further comprising:
a graphical user interface comprising of a listing of one or more faucet units in a residence able to be restricted from the graphical user interface for dissemination of hot water, based on at least one of a user feedback and a user input entered via the graphical user interface.

16. The faucet of claim 14, further comprising:
a graphical user interface permitting the grouping of a set of shower and faucet units within the residence such that the quantity of hot water available is approximately split between the shower and faucet units of the set.

17. The faucet of claim 14, further comprising:
a graphical user interface comprising of a graphic or value indicating the level of available hot water for use in a residence, wherein the value is dynamically determined using the hot water heater sensor in the hot water tank of the residence.

18. The user interface of claim 17, wherein the graphic or value dynamically and automatically changes as the hot water heater sensor indicates a quantity of hot water heater in the hot water tank changes.

19. The user interface of claim 17, further comprising:
a listing of one or more shower units in a residence able to be restricted from the graphical user interface for dissemination of hot water, based on at least one of a user feedback and a user input entered via the graphical user interface.

20. The user interface of claim 17, further comprising:
a listing of one or more faucet units in a residence able to be restricted from the graphical user interface for dissemination of hot water, based on at least one of a user feedback and a user input entered via the graphical user interface.
